(19) United States
(12) Patent Application Publication
(10) Pub. No.: US 2010/0107693 A1
(43) Pub. Date: May 6, 2010

(54) METHOD FOR DOPING GLASS

(75) Inventors: Markku Rajala, Vantaa (FI); Joe Pimenoff, Helsinki (FI); Jussi Wright, Lohja (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/525,993

(22) PCT Filed: Feb. 12, 2007
(86) PCT No.: PCT/FI07/50075

§ 371 Date: Aug. 5, 2009

(51) Int. Cl. C03C 15/00

(52) U.S. Cl. 65/30.13; 65/30.1

(57) ABSTRACT

The invention relates to a method for doping and/or colouring glass. In the method a two- or three-dimensional layer is formed on the surface of the glass, and the layer is further allowed to diffuse and/or dissolve into the glass to change the transmission, absorption, reflection and/or scattering of the electromagnetic radiation of the glass. The layer of nanomaterial includes at least one component that causes the above-mentioned change and at least one component that lowers the melting point of the above-mentioned component causing the change.

### FIELD OF THE INVENTION

The present invention relates to the method according to the preamble of claim 1 for doping and/or colouring glass, and especially to a method for doping glass, in which a two- or three-dimensional layer is formed of nanomaterial on the surface of the glass and allowed to diffuse and/or dissolve into the glass to change the transmission, absorption, reflection and/or scattering of electromagnetic radiation of the glass. In this context, colouring refers to doping glass in such a manner that the transmission or reflection spectrum of glass changes in the visible light region (approximately 400 to 700 nm) and/or ultraviolet region (200 to 400 nm) and/or near infrared region (700 to 2000 nm) and/or infrared region (2 mm to 50 mm). According to the invention, glass can be coloured in such a manner that a nano-sized material (size below 100 nm in two or three dimensions) is directed to the surface of glass, the temperature of which is at least 500° C., and the material consists of at least a glass-colouring compound, such as a transition metal oxide, and an element or compound that lowers the melting temperature of the oxide, such as an alkali metal oxide. The material dissolves and/or diffuses on the surface of glass and dopes it in such a manner that it turns into the colour characteristic of the colouring compound.

So as to be able to colour glass efficiently, i.e. in a sufficiently short time, at a temperature of 500 to 800° C., the material used in the colouring must be in nanosize. There are two reasons for this. Firstly, the diffusion rate of particles in a medium depends essentially on the size of the particles, and typically, the diffusion rate of particles of 10 nm is three times faster than particles of 1 micrometer. Secondly, the surface area and surface energy required for colouring reactions is bigger when the material is in nanosize.

For the sake of clarity, it should be noted that the size of less than 100 nm in three dimensions refers to particles with a diameter of less than 100 nm, and the size of less than 100 nm in two dimensions refers to thin films with a thickness of less than 100 nm. In the following, the text refers mainly to nano-sized particles, but the invention can also be applied using thin films.

The method of the invention can be used to colour flat glass, packing glass, utility or household glass, and special glass, such as optical fibre blanks.

### DESCRIPTION OF THE PRIOR ART

Colouring glass refers on a wide scale to altering the interaction between glass and electromagnetic radiation directed to it in such a manner that the transmission of the radiation through the glass, reflection from the surface of the glass, absorption into the glass, or scatter from the components in the glass changes. The most important wavelength regions are the ultraviolet region (e.g. preventing ultraviolet radiation of sun through glass), the visible light region (altering the colour of glass visible to the human eye), the near infrared region (altering the transmission of sun infrared radiation, or glass material used in active optical fibres), and the actual infrared region (altering the transmission of heat radiation).

Glass can be coloured in many different ways. Most typically, glass is coloured by adding into molten glass or its raw materials compounds of colour-producing metals, such as iron, copper, chromium, cobalt, nickel, manganese, vanadium, silver, gold, rare earth metals, or the like. Such a component will cause absorption or scattering of a certain wavelength region in the glass, thus producing a characteristic colour in the glass. However, adding a colouring substance in molten glass or raw materials makes changing the colour an extremely expensive and time-consuming procedure. Therefore, the manufacture of especially small batches of coloured glass is expensive.

Nickel oxide is used in colouring glass grey. When glass is made with a float process, the molten glass web runs on a tin bath. To prevent the tin bath from oxidizing, there is a reducing gas atmosphere on the tin bath. However, this causes nickel to reduce on the surface of glass, whereby metal nickel is formed on the surface of glass and creates a gauze or veil on the surface, which weakens the quality of the glass. To eliminate this problem, nickel-free grey glass compositions have been developed, such as the one disclosed in U.S. Pat. No. 4,339,541. The method is thus still based on colouring molten glass entirely.

U.S. Pat. No. 4,748,054 discloses a method for colouring glass with pigment layers. In this method, glass is sandblasted and different enamel layers are pressed on it to be then attached to the surface by burning. However, the chemical or mechanical wear resistance of such a glass is poor.

U.S. Pat. No. 3,973,069 discloses an improved method of colouring glass with diffusion. The improvement is provided with electric potential. The patent describes as a known method a method for colouring glass with colour metal ion diffusion in such a manner that glass is brought into contact with a medium that contains colouring ions, and the ions then diffuse from the medium to the glass. The glass colouring mechanism is then specifically based on the diffusion of ions and not on the diffusion of a nano-sized material with the glass. Similarly, the diffusing substance is not an oxide, but a metal ion. The patent only refers to colouring glass with silver. However, this colouring mechanism is not a pure diffusion, but an ion exchange reaction (silver/sodium ion).

U.S. Pat. No. 5,837,025 discloses a method for colouring glass with nano-sized glass particles. According to the method, glass-like, coloured glass particles are made and directed to the surface of the glass being coloured and sintered into transparent glass at a temperature of less than 900° C. The method differs from the present invention in that in the present invention, the particles diffuse inside glass and do not form a separate coating on the surface of the glass.

Finnish Patent FI98832, a method and device for spraying material, discloses a method that can be used in doping glass. In this method, the material being sprayed is directed in liquid form into a flame and transformed into droplets with the aid of a gas essentially close to the flame. This produces extremely small particles that are a nanometre in size quickly, inexpensively and in one step. The patent does not, however, describe the size of the produced liquid droplet. Neither does the patent describe the interaction between the produced particles and glass material.

Finnish patent FI114548 describes a method for colouring glass with colloidal particles. The patented method uses a flame spraying method to transport colloidal particles to the material being coloured. In the method, it is also possible to add other components to the flame, such as a glass-forming liquid or gaseous material, which assist the formation of correct-sized colloidal particles in the material. The patent does not state any other functions for the glass-forming liquid or gaseous material.

When using the method described in FI98832 for colouring glass, it has been found that a gauzy curtain may appear on the surface of the glass especially when colouring the glass in low temperatures of less than 700° C. The gauze is assumed to be due to crystalline areas remaining on the surface of the glass, whose proportion on the surface increases with the temperature difference between the melting point of the colouring component and glass surface. In cobalt oxide, whose melting point is 1795° C., the crystalline portion is larger than in iron oxide, whose melting point is 1369° C. or 1594° C. depending on the crystal form. In copper oxide, whose melting point is 1235° C. or 1326° C. depending on the crystal form, the crystalline portion is even smaller than in iron oxide.

When colouring glass with the method of FI98832 or some other method, in which the colouring is based on the diffusion and dissolution into glass of nanoparticles (particle diameter less than 100 nm), the colouring should, for economic reasons, be done when the temperature of the glass is 500 to 650° C. The colouring can then be done in a float line between the tin bath and cooling oven (temperature 550 to 630° C.) or in a glass tempering line (temperature approximately 620° C.). Colouring must then not produce crystal-line and/or gauzy areas on the surface of the glass.

### SUMMARY OF THE INVENTION

It is thus an object of the present invention to provide a method for doping and/or colouring glass in such a manner that the above-mentioned prior-art drawbacks are eliminated. The object of the invention is achieved by a method according to the characterising part of claim 1, which is characterised in that the layer of nanomaterial contains at least one component that provides the above-mentioned change, and at least one component that lowers the melting point of the component providing the above-mentioned change.

With the method of the present invention, glass can be coloured when the temperature of the surface of the glass is higher than 500° C.

The present invention is based on the idea that a nano-scale material is directed to the surface of the glass, the material consisting of at least two components: a metal compound providing a characteristic colour for the glass and a component lowering the melting point of the metal compound.

The lowering of the melting point of the compound can also take place in such a manner that the nanomaterial has components that trans-form the metal compound providing a characteristic colour into an amorphous form in the nanoparticle.

The lowering of the melting point of a compound can also take place in such a manner that the metal compound providing a characteristic colour and the component lowering the melting point of the compound are in different nanoparticles or films that are brought into contact with each other to produce essentially the same outcome as when these components are in the same nanoparticle or film.

### BRIEF DESCRIPTION OF THE FIGURES

The invention will now be described in greater detail by means of preferred embodiments and with reference to the attached drawings, in which

FIG. 1 is a flow chart showing an implementation method of the invention, and

FIG. 2 shows equipment used in implementing the invention.

### DETAILED DESCRIPTION OF THE INVENTION

The present invention relates to a method for colouring glass in a wavelength region that extends from ultraviolet radiation to infrared radiation. The temperature of the glass being coloured is above 500° C. The invention is based on directing to the surface of the glass a material less than 100 nanometres in size and consisting of a metal compound that provides a characteristic colour for the glass and a component that lowers the melting point of the metal compound.

Combinations of the colouring metal compound and the component lowering its melting point include CoO—V₂O₅, CoO—CaO, CoO—B₂O₃, Cu₂O—PbO, Cu₂O—SiO₂, CoO—SiO₂, CoO—TiO₂, MnO—SiO₂, MnO—Al₂O₃—SiO₂, MnO—Al₂O₃—Y₂O₃—SiO₂, Fe₂O₃—P₂O₅, and Mno—P₂O₅. It is apparent to a person skilled in the art that there are numerous compounds of this type and that the melting point of the compounds is lower than that of the colouring compound possibly only in some mixture ratios. The best result is obtained when the components form a eutectic mixture ratio, but the formation of such a eutectic mixture ratio is not necessary.

The nano-sized material essential for the present invention can be produced in many ways, such as with a flame method, laser ablation, sol-gel method, chemical vapour phase deposition (CVD), physical vapour phase deposition (PVD), atom layer deposition (ALD) method, molecular beam epitaxy (MBE) method, or the like. The following presents the use of a hot aerosol layering method to produce the material of the invention.

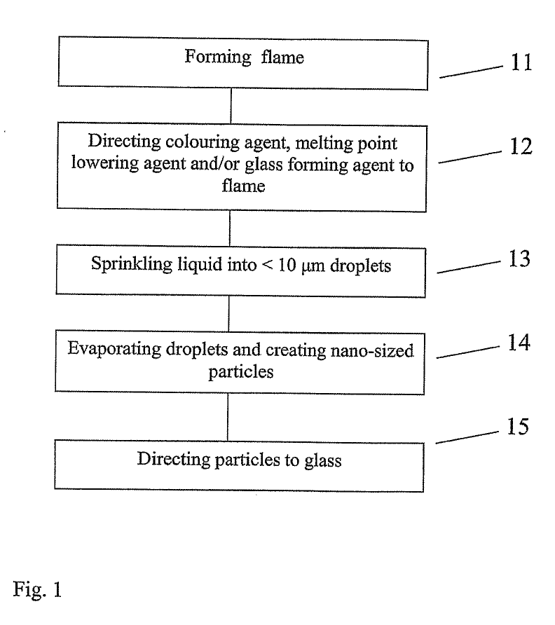

According to the flowchart of FIG. 1, the method of the invention forms a flame in step 11. In this context, the term ‘flame’ refers to any method of producing a high, local temperature. These include a fuel/oxygen flame, a plasma flame, an electric arc, or a high temperature provided with laser heating.

In step 12, a liquid raw material, for instance, is directed to the flame or close to it. The liquid raw material contains a metal compound that as a result of a chemical reaction or vaporisation/condensation in the flame produces nano-sized particles that contain a glass-colouring metal compound, typically metal oxide. The raw material fed into the flame in step 12 also contains a starting material that as a result of the chemical reaction and/or vaporisation/condensation in the flame produces nano-sized particles that contain a component that lowers the melting point of the compound of the glass-colouring metal compound. The nanoparticles created in step 12 can be particles that contain both the glass-colouring metal compound and the component that lowers the melting point of the metal compound. The nanoparticles created in step 12 can be crystalline or amorphous, as long as the melting temperature of the produced material is lower than that of the glass-colouring metal compound.

In the next step 13 of the method, at least one liquid component is transformed into droplets in such a manner that the formed droplets contain the colouring component, or a reaction in which the colouring component has partaken, the second component created as a result, or a compound of these two. Said droplets can preferably be made to contain said colouring component, if the colouring component is already dissolved in the liquid being made into droplets when it is fed into the flame.

It is essential for an efficient formation of nanoparticles created in the flame that the sprayed liquid material is brought into the flame in very small droplets. If the liquid material is brought into the flame in larger droplets, the process produces not only nanoparticles, but also larger particles that will not dissolve into the glass being coloured, and thus weaken the quality of the glass. The optically measured diameter of the droplets being created must therefore preferably be less than 10 micrometers, more preferably less than 6 micrometers, and most preferably less than 3 micrometers. The droplets can be produced by using generally known atomisation methods, such as gas-distributed atomisation, pressure atomisation, or ultrasound-based atomisation.

In the next step 14 of the method, the droplets and the components contained therein are evaporated and condensated, whereby the condensated components form ultra-small particles either through chemical reactions, mainly oxidisation reaction, or through nucleation/condensation. Evaporation and condensation can preferably be done with the heat of the flame or with an exothermally reacting solvent.

The composition, content, and size distribution of the created particles can be controlled by adjusting the operating parameters of the method, such as the temperature of the flame, flow rates of the gases, composition of the components fed to the flame, interrelations and absolute quantities of the components. Controlling the size distribution of the created particles is important, because the size of the particles plays a significant role in successful colouring of glass. It is especially essential that all particles be created through evaporation-nucleation, whereby no large residual particles are created in the process. The creation of residual particles can be avoided, if the droplet size of the liquid being sprayed is sufficiently small.

The particles created in the last step 15 of the method are brought into contact with the material to be coloured. The particles collect on the surface of the glass to be coloured mainly due to diffusion and thermophoresis. Owing to the large specific area of the particles, they diffuse and dissolve into the glass and provide to the glass a colour that is characteristic of the metal or metals in the particles. Due to the components that lower the melting point of the metal compounds in the particles, no crystalline or gauzy areas are formed in the glass, which would weaken the quality of the glass.

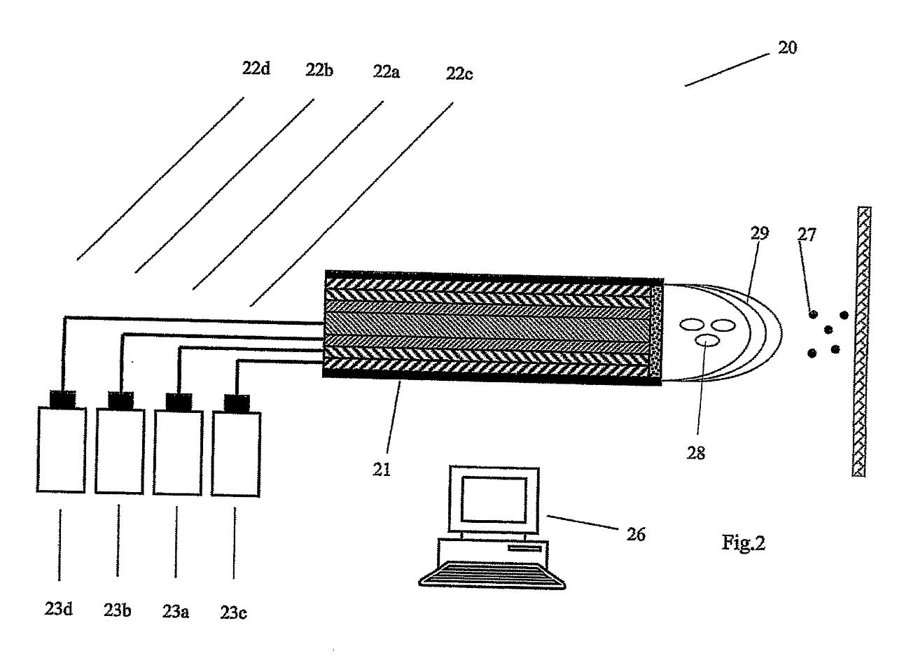

FIG. 2 shows equipment for colouring glass with the method of the invention. The shown equipment is a flame spraying apparatus based on a flame provided by burning gas, but it is clear to a person skilled in the art that instead of a gas flame, the heat source (thermal reactor) can also be a plasma flame, for instance.

The equipment 20 comprises a nozzle 21 that forms a flame 29 for spraying the colouring component 27. The nozzle is preferably made up of nested pipes 22a, 22b, 22c, 22d, through which the components used in the spraying can be conveniently brought to the flame 29.

To produce the flame 29, a combustion gas, such as hydrogen, is brought to the nozzle 21 from container 23b through pipe 22b serving as a feed channel. Correspondingly, the oxygen required for producing the flame is brought from container 23c to feed pipe 22c. Feed pipe 22c can be connected to feed pipe 22b, if a premixed flame is to be used. The combustion gas and oxygen flowing through the nozzle S form the flame 29. To control reactions in the flame or in its vicinity, it is also possible to feed a protective gas to the process from container 23a through feed channel 22a.

For the sake of simplicity, FIG. 2 only shows a situation, in which the component essential for colouring and the component essential for the formation of the eutectic mixture or partially eutectic mixture are already mixed or dissolved into the liquid to be atomised in container 23d. Possible modifications to the device, such as arranging more liquid feeds, vapour feeds, or gas feeds by increasing the number of nested or adjacent pipes, or by connecting more containers to the same inlet, or by bubbling the component with combustion gases or a protective gas, are apparent to a person skilled in the art.

In the device of FIG. 2, the liquid to be sprayed is fed from chamber 23d to supply channel 22d. Along the supply channel, the liquid is directed to the nozzle S that sprays it and is shaped in a manner known per se to achieve the desired flow properties. The liquid flowing through the nozzle S is made into droplets 28 preferably with a gas flowing from supply channel 22b. To achieve an as efficient droplet-to-nanoparticle transformation as possible, the diameter of the droplets must be at most 10 micrometers. Under the thermal energy released from the flame 29, the droplets 28 form particles 27 that are preferably directed to the glass being doped. Owing to the large specific area of the particles, they diffuse and dissolve into the glass and produce into the glass the colour characteristic of the metal or metals in the particles. Due to the components that lower the melting point of the metal compounds in the particles, no crystalline or gauzy areas are formed in the glass, which would weaken the quality of the glass.

The equipment 20 also comprises a control system 26 for controlling the operating parameters of the equipment in such a manner that as the droplets 29 and their contents evaporate and react/nucleate, the properties, such as content and particle size distribution, of the created particles 27 can be controlled.

### EXAMPLES p In the following, the invention will be described in more detail with examples.

### Example 1

### Colouring Glass Blue with Cobalt

It is known that cobalt oxide and silicon oxide form a eutectic mixture whose melting point is approximately 1377° C., i.e. approximately 400° C. lower than that of cobalt oxide. Such a mixture contains approximately 75% cobalt oxide and 25% silicon oxide.

The raw material of cobalt oxide was prepared by dissolving 25 g cobalt nitrate hexahydrate, Co(NO₃)₂•6H₂O, into 100 ml methanol. This solution was fed to middle channel 22d of the flame spraying equipment shown in FIG. 2 at 10 ml/min. The flame spraying equipment was positioned in such a manner that forming droplets and particles took place in an oven having a temperature of 600° C. Droplets were formed from the liquid by feeding hydrogen gas into channel 22b at a volume flow of 20 l/min, whereby the speed of the hydrogen gas at the nozzle S was approximately 150 m/s. The fast hydrogen gas flow formed droplets of less than 10 micrometers of the liquid flow. Nitrogen gas was fed from channel 22c at a flow rate of 15 l/min. Some of the nitrogen gas, approximately 5% of the volume flow, was first directed from feed bottle 23c through a bubbler. The bubbler contained silicon tetrachloride, SiCl₄, that evaporated with the nitrogen gas flow. After this, the nitrogen flow containing evaporated silicon tetrachloride was combined with the rest of the nitrogen flow and directed to channel 22c. The temperature of silicon tetrachloride was adjusted so that silicon tetrachloride produced, in comparison with the cobalt nitrate flow, such a mass flow that the ratio of cobalt oxide and silicon oxide created in the process was 3:1. Oxygen gas was fed to channel 22a at a volume flow of 10 l/min. The raw materials reacted in the flame and formed CoO—SiO₂ nanoparticles having an average diameter of approximately 30 nm. The particles partially agglomerated into particle chains. The particles were directed to flat glass that moved at a speed of 0.2 m/min in the 600-degree oven. The distance of the flame spraying equipment nozzle S from the surface of the glass was 155 mm. After the coating, the tensions in the glass were removed by keeping the glass for 15 minutes at a temperature of 500° C., after which the glass was cooled to room temperature during three hours. After the cooling, it could be seen that the glass had turned blue, and there was no gauze or crystalline materials in it.

### Example 2

### Colouring Glass Grey with Nickel

It is known that nickel oxide, NiO, and vanadium pentoxide, V₂O₅, form a mixture whose melting point at every mixture ratio is lower than the melting point of nickel oxide. In the exemplary test, nanoparticles were prepared containing approximately 60% nickel oxide and 40% vanadium pentoxide. The melting point of such a material is approximately 900° C., i.e. approximately 1000° C. lower than that of nickel oxide.

The raw material of nickel oxide was prepared by dissolving 25 g hexahydrate of nickel nitrate, Ni(NO₃)₂•6H₂O, into 100 ml ethanol. The raw material of vanadium pentoxide was prepared by dissolving 2.9 g vanadium chloride, VCl₂, into 100 ml ethanol. The solutions were then mixed together. This solution was fed to middle channel 22d of the flame spraying equipment shown in FIG. 2 at 10 ml/min. The flame spraying equipment was positioned in such a manner that forming droplets and particles took place in an oven having a temperature of 600° C. Droplets were formed from the liquid by feeding hydrogen gas to channel 22b at a volume flow of 20 l/min, whereby the speed of the hydrogen gas at the nozzle S was approximately 150 m/s. The fast hydrogen gas flow formed droplets of less than 10 micrometers of the liquid flow. Oxygen gas was fed to channel 22a at a volume flow of 10 l/min. The raw materials reacted in the flame and formed NiO—V2O5 nanoparticles having an average diameter of approximately 30 nm. The particles partially agglomerated into particle chains. The particles were directed to flat glass that moved at a speed of 0.2 m/min in the 600-degree oven. The distance of the flame spraying equipment nozzle S from the surface of the glass was 155 mm. After the coating, the tensions in the glass were removed by keeping the glass for 15 minutes at a temperature of 500° C., after which the glass was cooled to room temperature during three hours. After the cooling, it could be seen that the glass had turned grey, and there was no gauze or crystalline materials in it.

It is apparent to a person skilled in the art that as technology advances, the basic idea of the invention can be implemented in many ways. The invention and its embodiments are thus not limited to the examples described above, but may vary within the scope of the claims.

1. A method for doping glass, in which method a two- or three-dimensional layer is formed of nanomaterial on the surface of the glass and the nanoparticles are allowed to diffuse and/or dissolve into the glass to alter the transmission, absorption, reflection and/or scattering of electromagnetic radiation of the glass, which two- or three-dimensional layer of nanomaterial is formed by producing nanoparticles in diameter from liquid and/or gaseous and/or vaporous starting materials and directing them on to the surface of the glass, from where the nanoparticles diffuse and/or dissolve into the glass, the produced nanoparticles containing at least one first component that provides the above mentioned change, wherein the produced nanoparticles further contain at least one second component that lowers the melting point of the first component providing the above-mentioned change.

2. A method as claimed in claim 1, wherein the electromagnetic radiation is ultraviolet radiation, radiation in the wavelength region of visible light, near infrared radiation, or infrared radiation.

3. A method as claimed in claim 1, wherein the nanoparticles contain in the same or in separate nanoparticles at least one first component that changes the transmission, absorption, reflection and/or scattering of the electromagnetic radiation of the glass and at least one second component that lowers the melting point of the above-mentioned first component.

4. A method as claimed in claim 1, wherein nanoparticles having a diameter of less than 500 nanometres are produced from liquid and/or gaseous and/or vaporous starting materials with hot aerosol layering method, flame or chemical gas deposition (combustion on cvd) method, laser ablation method, or with some other nanoparticle production method.

5. A method as claimed in claim 4, wherein the liquid droplets produced in the atomization part of the hot aerosol layering method have a diameter of less than 10 micrometers.

6. A method as claimed in claim 1, wherein thin films having a thickness of less than 1000 nanometres are produced from liquid and/or gaseous and/or vaporous starting materials, which films then diffuse and/or dissolve in the glass.

7. A method as claimed in claim 6, wherein thin films having a thickness of less than 1000 nanometres are produced from liquid and/or gaseous and/or vaporous starting materials with chemical vapour phase deposition (CVD), physical vapour phase deposition (PVD), atom layer deposition (ALD), molecular beam epitaxy (MBE) deposition, pulsed laser deposition (PLD), sol-gel method, or some other thin film deposition method.

8. A method as claimed in claim 6, wherein the films contain in the same or in separate films at least one first component that changes the transmission, absorption, reflection and/or scattering of the electromagnetic radiation of the glass and at least one second component that lowers the melting point of the first component.

9. A method as claimed in claim 1, wherein the first component that changes the transmission, absorption, reflection and/or scattering of the electromagnetic radiation of the glass and the second component that lowers the melting point of the first component contain at least one of the following component combinations:
transition element compound and alkali metal compound,
transition element compound and earth alkali metal compound,
transition element compound and semi-metal compound,
lanthanoide compound and alkali metal compound,
lanthanoide compound and earth alkali metal compound, and
lanthanoide compound and semi-metal compound.

10. A method as claimed in claim 1, wherein glass is coloured at a glass temperature of less than 700° C.

11. A method as claimed in claim 1, wherein glass is coloured during a float process.

12. A method as claimed in claim 1, wherein glass is coloured during a glass tempering, bending, lamination, or moulding process.

13. A method as claimed in claim 1, wherein glass is coloured during a process where a glass article is blown in a mould.
